(19) United States
(12) Patent Application Publication
(10) Pub. No.: US 2011/0121028 A1
(43) Pub. Date: May 26, 2011

(54) DISPENSER AND FLEXIBLE POUCH FOR LIQUID FOOD PRODUCT

(75) Inventor: Gerald A. Rusch, Fond du Lac, WI (US)

(73) Assignee: SERVER PRODUCTS, INC., Richfield, WI (US)

(21) Appl. No.: 12/779,321

(22) Filed: May 13, 2010

Related U.S. Application Data
(60) Provisional application No. 61/177,690, filed on May 13, 2009.

(51) Int. Cl. B05C 17/01; B65D 83/76

(52) U.S. Cl. 222/96; 222/105; 222/95

(57) ABSTRACT

A dispensing assembly for dispensing a liquid food product includes a flexible pouch received within a dispenser. An actuating structure within the dispenser exerts a force on the flexible pouch to dispense the food product through a cover member having one or more product openings. A portion of the flexible pouch is folded over an external portion of a cover secured to the dispenser and an attachment collar is secured thereto by a threaded connections. The dispenser can be used with different types of flexible pouches and can dispense food product through multiple openings.

### CROSS-REFERENCE TO RELATED APPLICATION

The present application is based on and claims priority to U.S. Provisional Patent Application Ser. No. 61/177,690 filed on May 13, 2009.

### BACKGROUND

The present disclosure generally relates to a dispenser assembly for dispensing liquid food product. More specifically, the present disclosure relates to a dispensing assembly that includes a collapsible, flexible pouch including the liquid food product and a dispenser that receives the flexible pouch and includes an actuator for pushing the food product out of the flexible pouch for dispensing.

### SUMMARY

The present disclosure relates to a dispensing assembly including a flexible pouch having an outer wall that defines an open interior for receiving and retaining the liquid food product. The flexible container is sized to be received within an open interior of a dispenser. When an actuating structure of the dispenser compresses the flexible pouch, the liquid food product flows out of an open end of the flexible pouch.

The dispenser of the present disclosure receives a cover member that can be removed from an outer housing of the dispenser. The cover member and the outer housing combine to receive the flexible pouch filled with food product to be dispensed. When the flexible pouch is received within the open interior of the dispenser housing, an open end of the flexible pouch extends past the end of the dispenser and directs the food product through a valve.

During dispensing of the liquid food product, the actuating structure of the dispenser compresses the flexible pouch to force food product out of the dispensing spout. In one embodiment, the actuating structure is a movable piston contained within the open interior of the dispenser.

### BRIEF DESCRIPTION OF THE DRAWINGS

The drawings illustrate the best mode presently contemplated of carrying out the disclosure. In the drawings:

FIG. 1 is a perspective view illustrating a food product dispenser constructed in accordance with a first embodiment of the present disclosure;

FIG. 2 is a sectional view of the first embodiment of the food product dispenser;

FIG. 3 is a magnified view taken along line 3-3 of FIG. 2;

FIG. 4 is an exploded view of FIG. 3;

FIG. 5 is a top plan view of the flexible pouch utilized with the food product dispenser of the first embodiment;

FIG. 6 is a perspective view of a second embodiment of the food product dispenser;

FIG. 7 is a side view of the second embodiment of the food product dispenser;

FIG. 8 is a section view of the second embodiment of the food product dispenser;

FIG. 9 is a perspective view illustrating a third embodiment of the food product dispenser;

FIG. 10 is a side view of the third embodiment of the food product dispenser;

FIG. 11 is a section view of the third embodiment of the food product dispenser; and

FIG. 12 is a top plan view of a flexible pouch utilized with the food product dispenser of the second and third embodiment of the present disclosure.

### DETAILED DESCRIPTION OF THE DRAWINGS

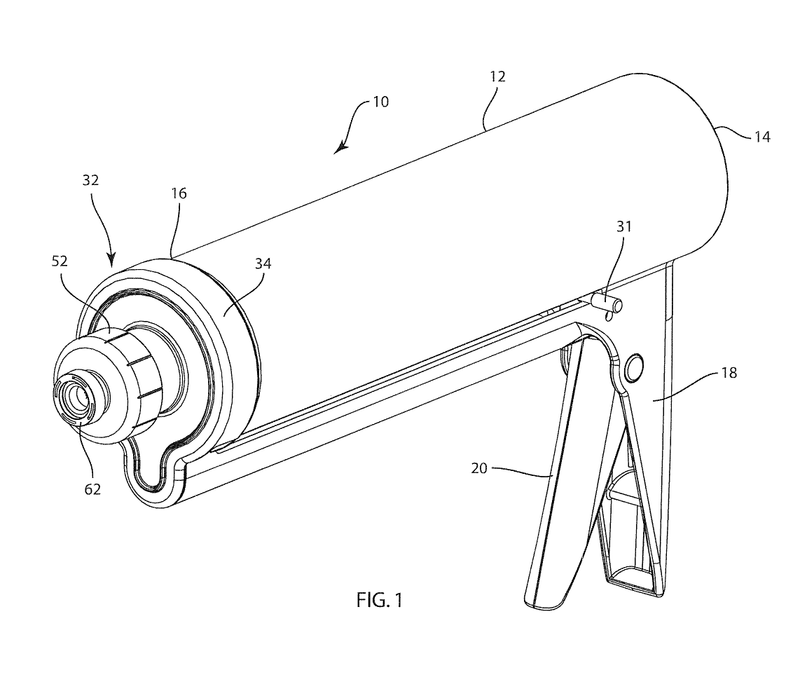

FIG. 1 illustrates a food product dispenser 10 that is particularly useful in dispensing liquefied food products, such as condiments, whipped cream toppings, sauces or other similar types of liquefied food products. The food product dispenser 10 generally includes a cylindrical outer housing 12 that extends from a back end 14 to a front end 16. In the embodiment shown in FIG. 1, the food product dispenser 10 includes a handle 18 and a user-actuated trigger 20. Although the handle 18 and trigger 20 are shown positioned at the back end 14, the handle 18 and trigger 20 could be moved closer to the center of the housing 12 to modify the weight distribution of the dispenser 10.

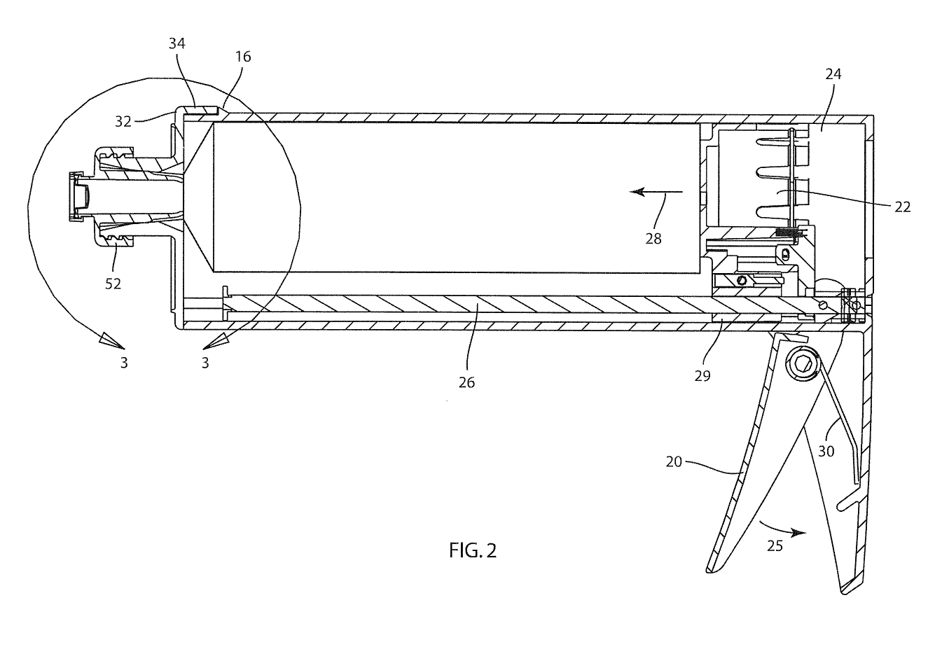

As illustrated in FIG. 2, the trigger 20 forms part of an actuating structure of the product dispenser 10. Specifically, the trigger 20 is coupled to a piston 22 that is movable within the open interior 24 of the cylindrical outer housing 12. The actuating structure functions such that upon each movement of the trigger 20 in the direction shown by arrow 25, an actuation rod 26 moves the piston 22 in the direction shown by arrow 28 toward the front end 16. A bias spring 30 returns the trigger 20 to the position shown in FIG. 2.

The piston 22 is mounted to a pawl 29 that moves along the length of the actuation rod 26. When the piston 22 is between the fully retracted position shown in FIG. 2 and a fully extended position, the piston 22 can be moved back to the retracted position shown in FIG. 2 through actuation of a pawl release 31 shown in FIG. 1. The pawl release 31 is connected to the pawl 29 such that the user can grasp the pawl release 31 and manually return the piston to its fully retracted position. The pawl release 31 allows the user to retract the piston to release pressure on the food contents contained within the collapsible bag when desired, such as if the piston becomes jammed during dispensing of the liquid food product.

Referring back to FIG. 1, the front end 16 of the outer housing 12 receives a removable cover 32. As illustrated in FIG. 2, the cover 32 includes an outer flange 34 that holds the cover 32 in the position shown. The cover 32 can be removed from the outer housing 12 to reload the dispenser 10 with a flexible product container or pouch including the food product to be dispensed, as will be described in detail below.

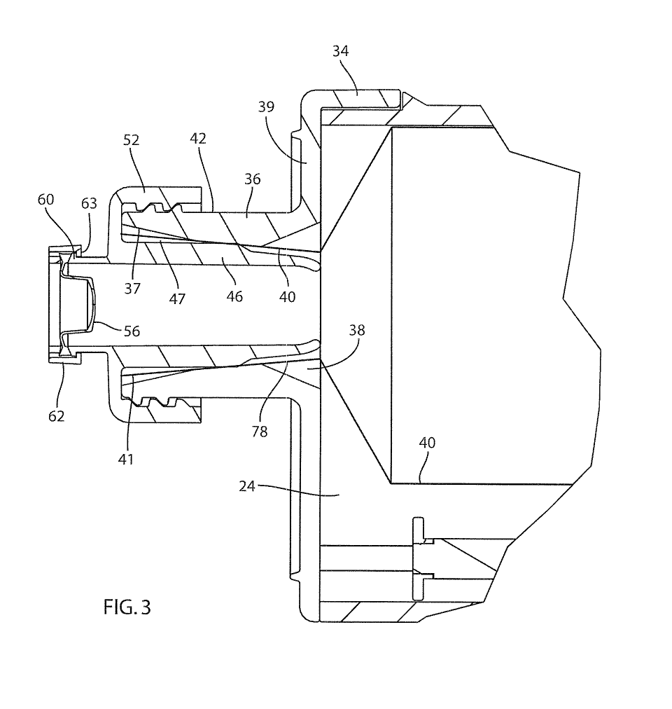

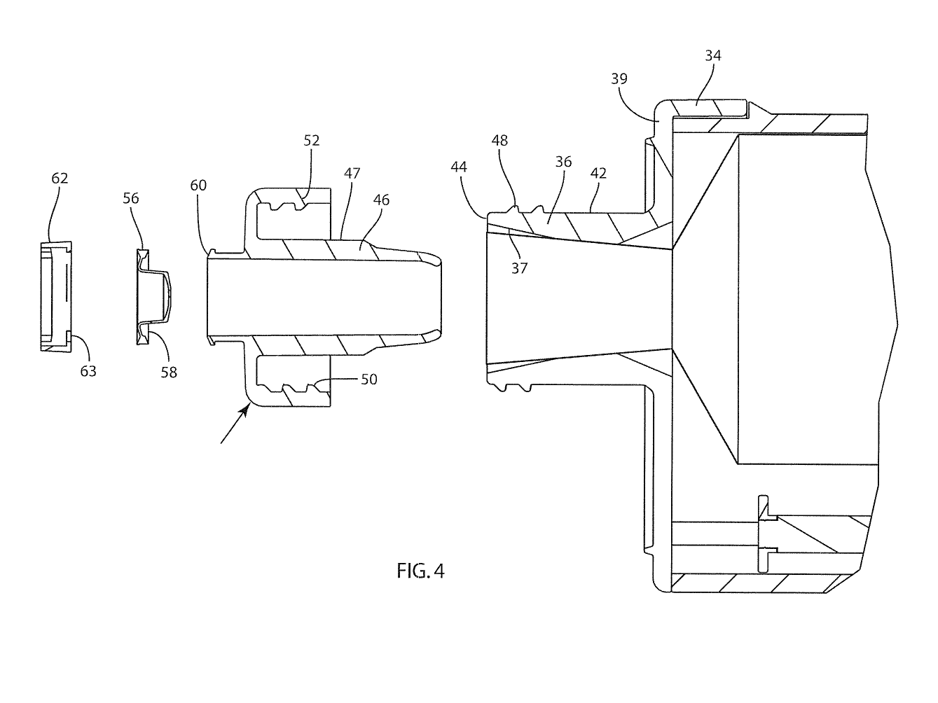

As illustrated in the magnified views of FIGS. 3 and 4, the cover 32 includes a spout 36 that extends from the end wall 39. The spout 36 defines a dispensing opening 38 that is open to the interior 24 of the housing 12. In the embodiment shown in FIGS. 3 and 4, the open interior 24 receives a flexible pouch 40 which will be described in greater detail below. The flexible pouch 40 extends through the spout 36 and an open end 41 of the flexible pouch 40 is positioned at or near the outer end 44 of the spout 35

The spout 36 includes external threads 48 that interact with internal threads 50 formed along the inner surface of an attachment collar 52. As illustrated in FIGS. 3 and 4, the attachment collar 52 includes a center tube 46 defined by an outer surface 47. When the attachment collar 52 is threadedly attached to the spout 36, the outer surface 47 of the center tube 46 engages a tapered inner wall 37 of the spout 36. As illustrated in FIG. 3, when the attachment collar 52 is threadedly attached to the spout 36, the center tube 46 moves into the spout 36 until the outer surface 47 begins to contact the tapered inner wall 37. The contact between the tapered inner wall 37 and the outer surface 47 securely holds the spout portion 78 of the flexible pouch 40 in place.

In the embodiment shown in FIGS. 3 and 4, the attachment collar 52 receives a one-way valve 56 preferably formed from a silicone material. The valve 56 includes an outer seating surface 58 that is received along a shoulder 60 of the attachment collar 52. A valve retainer 62 includes a projection 63 that snaps onto the attachment collar 52 below the shoulder 60 to hold the valve 56 in position, as is best illustrated in FIG. 3. The one-way silicone valve 56 ensures that food product flows only out of the dispenser while preventing the ingress of contaminants or other material. Additionally, the valve 56 prevents air contact with the food product, which prevents the food product from drying out when in the flexible pouch.

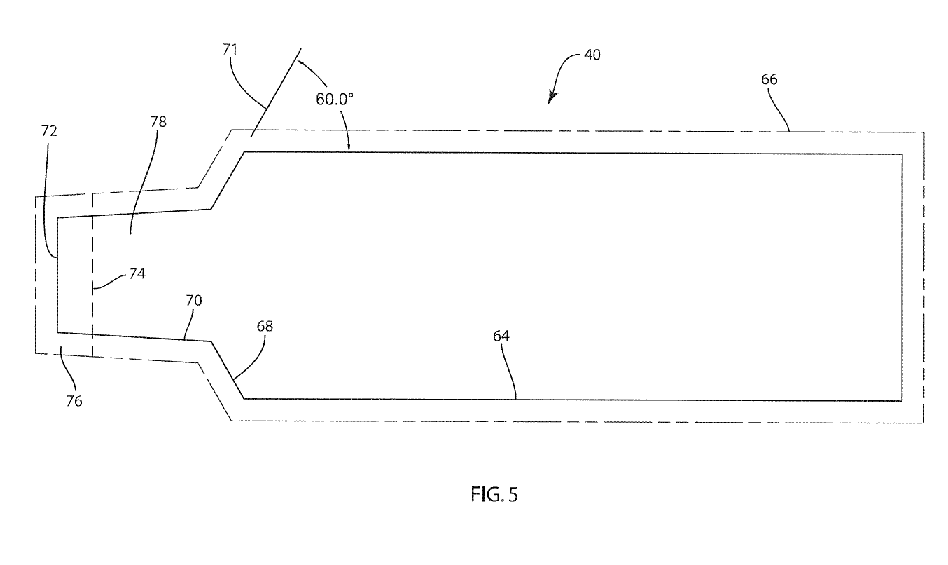

FIG. 5 illustrates a top plan view of one embodiment of the flexible pouch 40. The flexible pouch 40 is formed from two plies of a flexible material, such as plastic, that are joined to each other along a heat seal 64. As illustrated in FIG. 5, the heat seal is spaced inwardly from the outer edge 66 of the flexible pouch 40. The heat seal 64 is angled inward along a tapered section 68. The heat seal then extends at a reduced angle along a spout line 70 to define a spout section 78. As shown, the angle 71 in the illustrated embodiment is 60°, although other angles are contemplated. The heat seal is finally sealed along the end line 72. In the embodiment illustrated, the flexible pouch includes a line of perforation 74. The line of perforation 74 extends inwardly of the end line 72 and defines the open end 41 of the flexible pouch 40.

When the flexible pouch 40 is initially filled with food product, the heat seal 64 prevents the food product from exiting the flexible pouch 40. When an operator desires to dispense product from the flexible pouch 40, the user grasps the end portion 76 at a location between the line of perforation 74 and the end line 72. By pulling on the end portion 76, the user separates the end portion 76 of the flexible pouch along the line of perforation 74. Since the line of perforation 74 extends across the spout section 78, the user can utilize the tear off end portion 76 to open the flexible pouch 40.

Preferably, the flexible pouch 40 is inserted into the open interior 24 of the food product dispenser 10, as shown in FIG. 2 prior to opening. When in this position and before the attachment collar 52 is secured to the spout 36, the end section 76 of the spout portion 78 can be pulled through the open outer end 44 of the spout 36. Once the end section 76 has been pulled through the spout, the end section 76 is separated from the spout portion 78 to open the flexible package. Once the flexible package has been opened, the attachment collar 52 is threadedly attached to the spout 36 to secure the flexible pouch between the center tube 46 and the tapered inner wall 37, as shown in FIG. 3.

As described above, the flexible pouch 40 in the preferred embodiment includes tear off end section 76 that can be utilized to not only open the flexible pouch but also to pull the spout portion of the flexible pouch through the spout 36 formed on the product dispenser. Once the tear off end section 76 has been utilized to position the flexible pouch, the tear off end section 76 is used to open the flexible pouch prior to product dispensing.

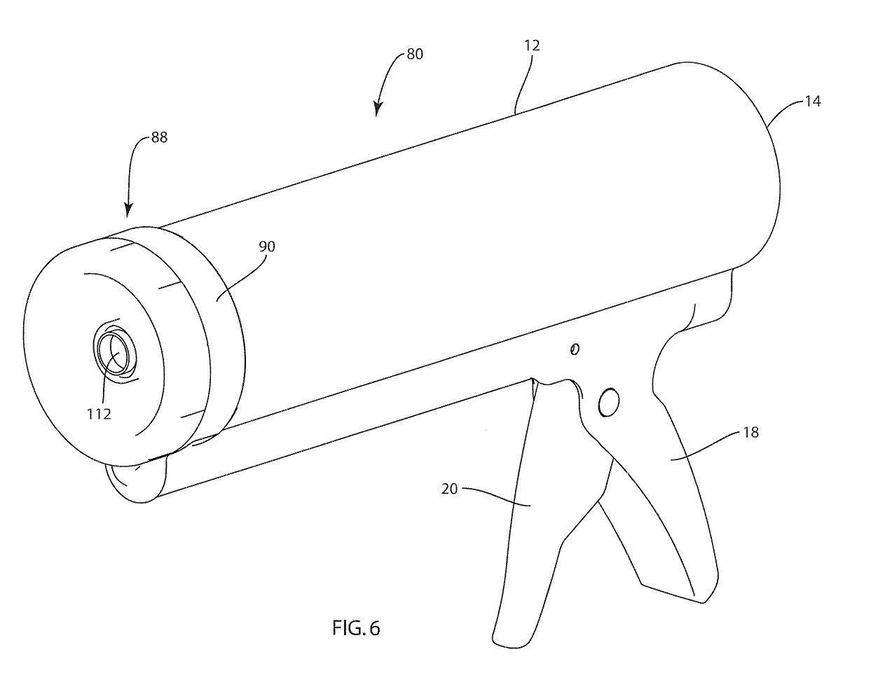

FIG. 6 illustrates a second embodiment of a food product dispenser 80. Since the second embodiment includes many of the same elements as the first embodiment shown in FIGS. 1-4, similar reference numerals will be used.

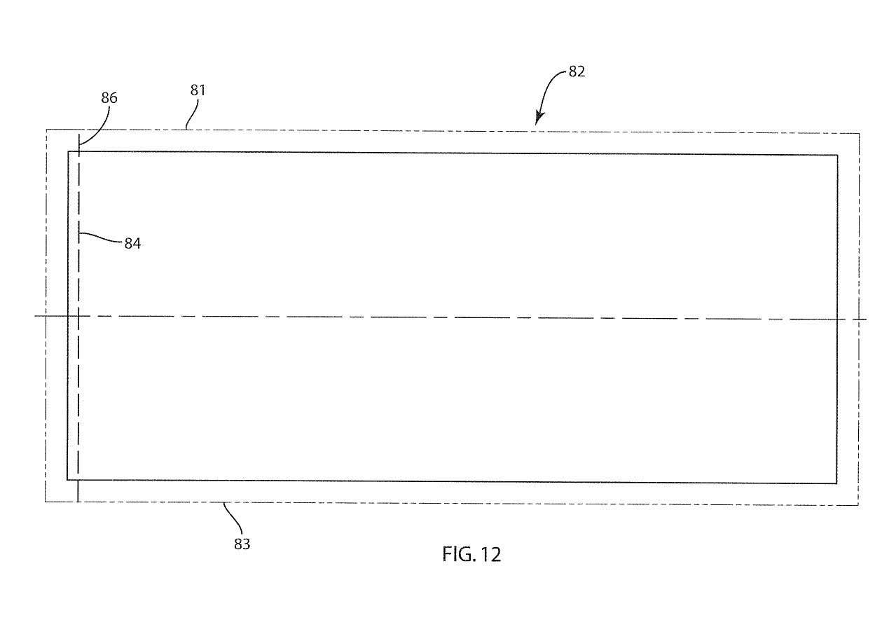

In the second embodiment shown in FIG. 6, the food product dispenser 80 is designed to utilize a different type of flexible pouch 82 having an open end 84 defined by a tear line 86, as best shown in FIG. 12. In the embodiment shown in FIG. 12, the tear line 86 extends across the entire width of the flexible pouch 82 from the first side edge 81 to the second side edge 83.

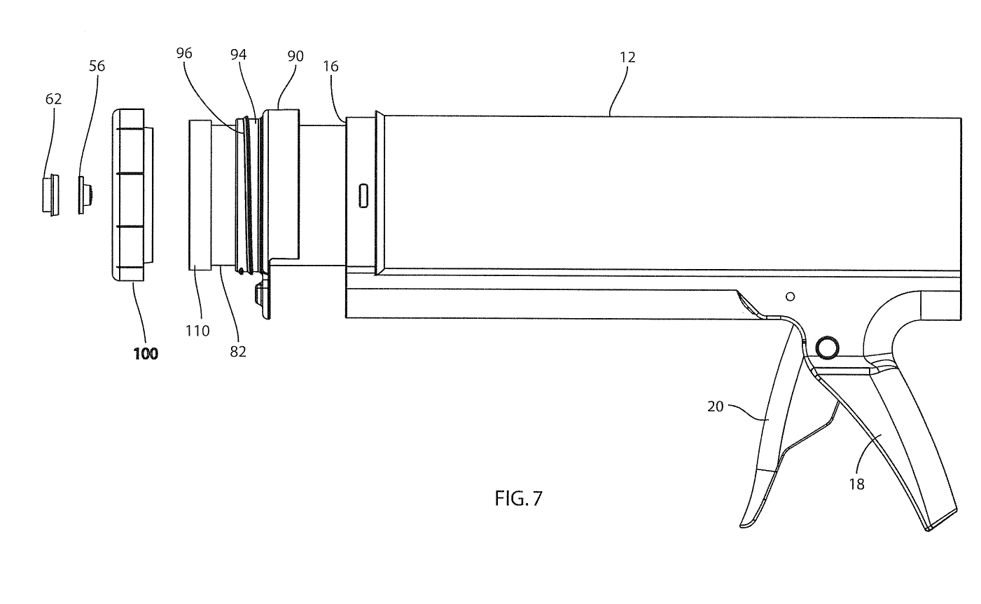

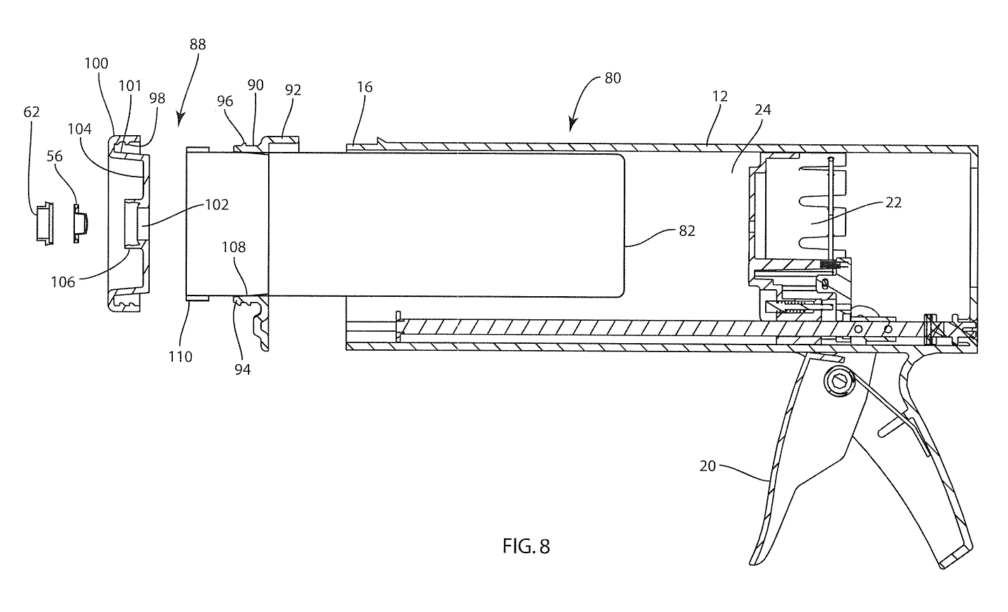

Referring back to FIG. 6, the food product dispenser 80 includes a cover assembly 88 having a different configuration than the cover 32 shown in the first embodiment. As can best be seen in FIG. 8, the cover assembly 88 is a two-piece item including a cover 90 that is attached to the front end 16 of the housing 12. The cover 90 includes an outer flange 92 that snaps into place along the front end 16 of the housing 12. As can be seen in FIG. 7, the cover 90 defines a spout 94 that includes external threads 96. The external threads 96 receives a corresponding internal thread 98 formed as part of an attachment collar 100.

As can be seen in FIG. 8, the attachment collar 100 defines a single, central product dispensing opening 102. The product opening 102 is formed in the face surface 104 of the attachment collar 100. The central opening 102 is defined by a center wall 106 configured to receive both the valve 56 and the valve retainer 62. The valve 56 and the valve retainer 62 are similar to these components shown in the first embodiment of FIGS. 1-4 and are attached within the cavity formed by the center wall 106.

As illustrated in FIG. 8, when the piston 22 is moved to its retracted position, the flexible pouch 82 can be inserted into the open interior 24. Prior to opening the flexible pouch 82 by tearing along the line of perforation 86 shown in FIG. 12, the cover 90 is slid over the end of the flexible pouch 82. Once the cover 90 is in place, the flexible pouch 82 is inserted through the central opening 108 into the open interior 24. Once the flexible pouch 82 has been inserted through the central opening 108, the flexible pouch 82 can be opened by tearing along the line of perforation 86 shown in FIG. 12.

After the flexible pouch 82 has been opened, a section 110 of the flexible pouch 82 can be folded over the cylindrical spout 94 of the cover 90 including the external threads 96. Once this section of the flexible pouch has been folded over, the attachment collar 100 is threadedly attached to the cover 90. The threaded connection between the attachment collar 100 and the cover 90 securely holds the open end of the flexible pouch in position.

Once the flexible pouch 82 has been securely positioned as shown in FIGS. 7 and 8, the user can depress the trigger 20 to move the piston 22 toward the front end 16 of the housing 12. The movement of the piston 22 compresses the food product contained within the flexible pouch 82 and forces the food product out of the central product opening 102. Since the outer end of the flexible pouch 82 is folded over the cover 90, the liquefied food product will exit only through the central product opening 102. Valve 56 controls the fluid flow out of the food product dispenser 80. In the embodiment shown in FIGS. 6-8, the food product dispenser 80 is configured to have only a single product outlet 112, as shown in FIG. 6.

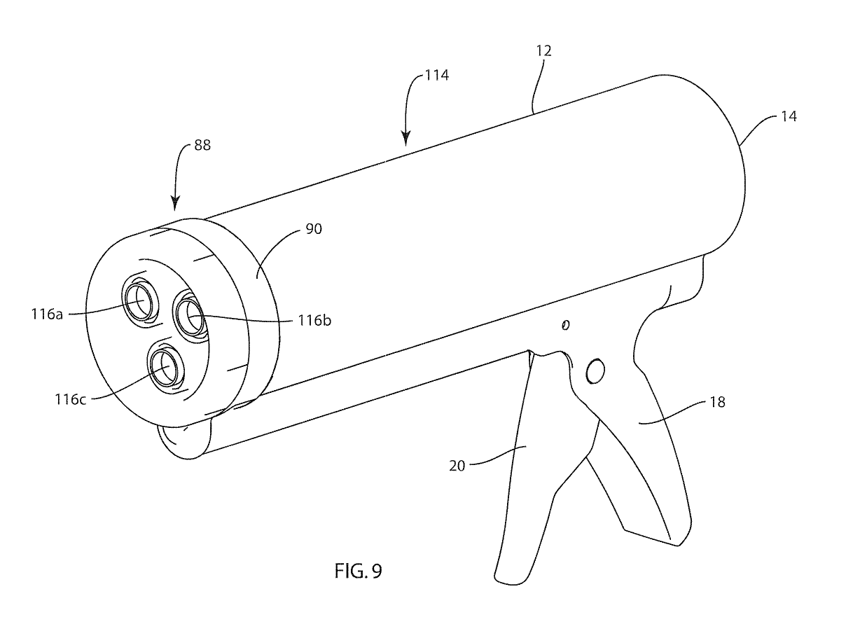

In the third embodiment of the food product dispenser, referred to by reference numeral 114 in FIG. 9, the food product dispenser includes three product outlets 116a, 116b and 116c. In the embodiment shown in FIG. 9, the user can depress the trigger 20 and an equal amount of food product is dispensed from each of the food product outlets 116a-116c. The food product dispenser 114 shown in FIG. 9 is particularly desirable when a wide distribution of the food product is desired. In one example, the food product dispenser 114 could be utilized to dispense ketchup onto three different locations on a bun simultaneously.

The third embodiment of the food product dispenser 114 utilizes the same flexible pouch 82 as shown in the second embodiment of FIGS. 6-8. The only component of the food product dispenser 114 different from the second embodiment shown in FIG. 8 is the attachment collar 118. The attachment collar 118 includes three product openings 120 for dispensing the liquefied food product. Each of the product openings 120 is surrounded by an annular wall 122 configured to receive both a valve 56 and a valve retainer 62. Since the embodiment of the food product dispenser 114 includes three product outlets, the attachment collar 118 is designed to include the three product openings 120. Although three product openings are illustrated, it should be understood that the attachment collar 118 could be designed to include either two or four product openings while operating within the scope of the present disclosure.

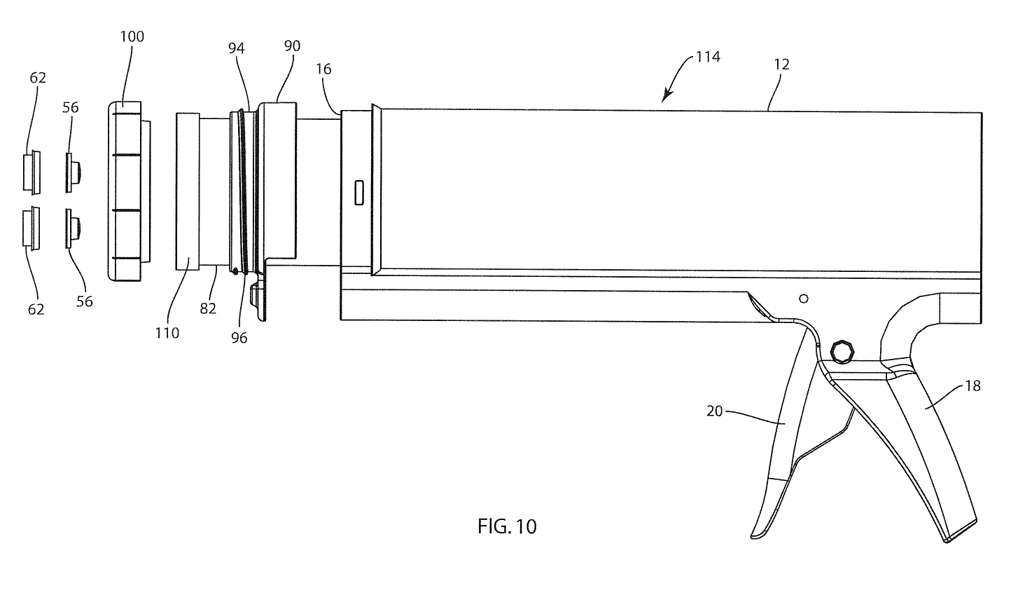

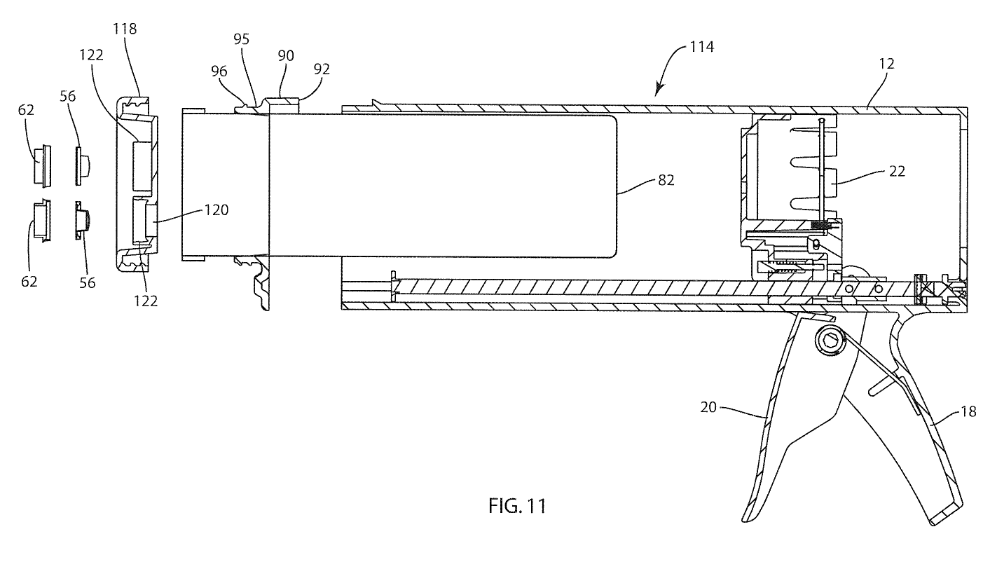

In each of the three embodiments shown in the drawing Figures, the outer housing 12 and the operating mechanism including the trigger 20 and handle 18 are identical. The embodiments are distinguished by the type of flexible pouch utilized and the end dispensing configuration. In the first embodiment of FIGS. 1-4, a flexible pouch 40 is utilized having a defined spout. In the second embodiment of FIGS. 6-8 and the third embodiment of FIGS. 9-11, a flexible pouch 82 having an open end of the same diameter as the outer diameter of the flexible pouch is utilized.

Although the embodiments of FIGS. 6-11 are described as being utilized with a flexible pouch including food product, it should be understood that the flexible pouch could be loaded into the open interior of the product dispenser prior to filling. In such an embodiment, the flexible pouch would be loaded into the open interior of the product dispenser and wrapped over the outer surface 95 of the cover 90. Once in this position, the flexible pouch 82 could be filled with food product. In such an embodiment, an operator could load the food product dispenser with any type of food product desired and not have to rely upon prefilled product pouches.

Once the flexible pouch 82 is filled, the attachment collar 100 or 118 is attached to the external threads 96 to secure the flexible pouch 82 and prevent spillage.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A system for dispensing a liquefied food product, comprising:
a food product dispenser having an outer housing that defines an open interior and an open front end;
a piston positioned within the open interior, the piston being selectively movable from a back end of the outer housing to the front end of the outer housing;
a flexible pouch filled with the liquefied food product and positioned within the open interior between the piston and the open first end;
a cover member attached to the open front end of the outer housing, the cover member having a dispensing spout, wherein a portion of the flexible pouch extends through an interior of the dispensing spout; and
an attachment collar removably attached to the dispensing spout, wherein when the attachment collar is attached to the dispensing spout, the portion of the flexible pouch is held between the attachment collar and the dispensing spout.

2. The system of claim 1 wherein the dispensing spout includes external threads and the attachment collar includes internal threads, wherein the flexible pouch is entrapped between the external threads of the dispensing spout and the internal threads of the attachment collar when the attachment collar is attached to the dispensing spout.

3. The system of claim 1 wherein the attachment collar includes a center tube that engages a tapered inner wall of the dispensing spout upon the threaded movement of the attachment collar along the dispensing spout.

4. The system of claim 1 wherein the dispensing spout receives at least one valve member.

5. The system of claim 4 wherein the valve member is retained at the outer end of the dispensing spout by a valve retainer.

6. The system of claim 1 wherein the flexible pouch includes a perforated outer end that is removable prior to dispensing of the liquefied food product.

7. The system of claim 4 wherein the dispensing spout receives a plurality of valve members.

8. The system of claim 1 further comprising a handle and trigger attached to the outer housing near the back end of the outer housing, wherein the piston is movable within the open interior upon activation of the trigger.

9. The system of claim 8 further comprising a pawl release associated with the piston, wherein the piston is movable along with the movement of the pawl release.

10. A system for dispensing a liquefied food product, comprising:
a food product dispenser having an outer housing that defines an open interior and an open front end;
a piston movably positioned within the open interior, the piston being selectively movable from a back end of the outer housing to the front end;
a flexible pouch filled with the liquefied food product and positioned within the open interior between the piston and the first end, the flexible pouch including a main body portion and a reduced diameter spout portion;
a cover member attached to the open front end of the outer housing, the cover member having a dispensing spout, wherein the spout portion of the flexible pouch extends through an interior of the dispensing spout; and
an attachment collar removably attached to the dispensing spout, wherein when the attachment collar is attached to the dispensing spout, the spout portion of the flexible pouch is held between the attachment collar and the spout.

11. The system of claim 10 wherein the dispensing spout includes external threads and the attachment collar includes internal threads, wherein the flexible pouch is entrapped between the external threads of the dispensing spout and the internal threads of the attachment collar when the attachment collar is attached to the dispensing spout.

12. The system of claim 10 wherein the attachment collar includes a center tube that engages a tapered inner wall of the dispensing spout upon the threaded movement of the attachment collar along the dispensing spout.

13. The system of claim 10 wherein the dispensing spout receives at least one valve member.

14. The system of claim 13 wherein the valve member is retained at the outer end of the dispensing spout by a valve retainer.

15. The system of claim 10 wherein the flexible pouch includes a perforated outer end that is removable prior to dispensing of the liquefied food product.

16. The system of claim 13 wherein the dispensing spout receives a plurality of valve members.

17. The system of claim 10 further comprising a handle and trigger attached to the outer housing near the back end of the outer housing, wherein the piston is movable within the open interior upon activation of the trigger.

18. The system of claim 17 further comprising a pawl release associated with the piston, wherein the piston is movable along with the movement of the pawl release.
